(19) United States
(12) Patent Application Publication
(10) Pub. No.: US 2008/0289842 A1
(43) Pub. Date: Nov. 27, 2008

(54) WALK BEHIND POWER TOOL VIBRATION CONTROL HANDLE

(76) Inventors: LARRY JAKE CHAPPLE, BOISE, ID (US); DOUGLAS SAMUEL PRAIRIE, BOISE, ID (US)

Correspondence Address: DYKAS, SHAVER & NIPPER, LLP, P.O. BOX 877, BOISE, ID, 83701-0877, US

(21) Appl. No.: 11/753,125

(22) Filed: May 24, 2007

(51) Int. Cl. B25D 17/04

(52) U.S. Cl. 173/162.2

(57) ABSTRACT

Disclosed is a vibration dampening handle for power tools. It includes a frame member attached to the power tool itself, and a handle assembly, which is attached to the frame member via connection to resilient material attached to an isolator chassis assembly located at a vibration node point of the frame member. The vibration dampening handle may also include a height adjustment mechanism.

### FIELD OF THE INVENTION

The present invention generally relates to a vibration control handle for use on power tools, and more particularly to a vibration control handle having a vibration dampening connection to a main tool handle, such as the main handle of a walk-behind power trowel.

### BACKGROUND OF THE INVENTION

Power tools are often operated through a handle assembly that extends from the operator's hands at a standing height to the main body of the tool at the floor or ground level. Such tools may comprise tools for finishing wet cement, cutting dried cement, polishing wood floors, or sanding wood floors. These tools impart considerable vibrations through the handle to the operator's hands and arms. Such vibration transmissions are uncomfortable nuisances that potentially cause fatigue, stress, and injuries.

Prior attempts to dampen vibrations typically relied on use of a dampening system attached to a frame member with a resilient material allowing partial dissipation of vibrations. The dampening system would dampen the amplitude of the vibrations transmitted to it. However, there is still a need for improved handles that better dampen vibrations produced by the operation of the tool.

### SUMMARY OF THE INVENTION

Embodiments of the present handle provide considerable vibration dampening while retaining controllability of the power tool.

The typical power tool that this would be used on is a walk-behind cement-finishing device that has rotating trowel blades in order to smooth and finish a concrete floor. Other power tools could also benefit from a handle with this design, particularly those power tools that are used to work on floors, which could include sanders, buffers, polishers, grinders, and other power tools.

The power tool for use with this handle includes a frame member that is attached to the power tool. Attached to the frame member is a handle assembly, which the operator grasps during operation of the power tool. The unwanted vibrations transmitted to the operator during operation of the power tool are transferred, at least in part, in a wave form through the power tool's frame member to its handle and then to the operator's hands and arms. Such wave forms have node points where there is relatively little or no vibration. Methods for determining node points are well known in the industry. Node-point detection requires only ordinary research, analysis, and testing of equipment. By attaching a power tool's handle assembly at a node point on the frame member of the tool, the amount of vibration transferred from the tool to the operator's hands and arms is decreased.

In one preferred embodiment of the present invention, the handle assembly for a power tool is attached to the frame member of the power tool via an isolator chassis assembly that is located at a vibration node point of the frame member. The isolator chassis is made up of two plates, one mounted to the frame member and the other mounted to the handle assembly. Resilient material, which is preferably at least one grommet made of rubber or a rubber-like material, such as polychloroprene, or polyurethane, is located between the frame-member-mounted isolator plate and the handle-assembly-mounted isolator plate. Much of the vibration of a power tool is generated in the upper portion of the frame member, and the resilient material helps dampen any vibrations transmitted to the user. Accordingly, in this embodiment, the frame member connects to the frame-member-mounted isolator plate, which contacts resilient material, which contacts the handle-assembly-mounted isolator plate, which connects to the handle assembly. In this way, there is no metal-to-metal contact between the frame member and the handle assembly. The decreased metal-to-metal contact further helps to limit the transfer of vibrations to the operator.

As a further preferred embodiment of the invention, the handle assembly could include an adjustable height mechanism implemented as a threaded adjustment rod with interlocking surfaces corresponding to oppositely-interlocking surfaces on portions of the handle assembly and a fastener threaded through portions of the handle assembly and through the adjustment rod.

The purpose of the foregoing summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out this invention. As will be realized, the invention is capable of modification in various obvious respects all without departing from the invention. Accordingly, the drawings and description of the preferred embodiments are to be regarded as illustrative, and not as restrictive.

### BRIEF DESCRIPTION OF THE DRAWINGS

FIG. 1 is a partial, perspective view of components of a power tool handle according to an embodiment of the invention.

FIG. 2 is a partial, exploded view of components of a power tool handle according to the embodiment in FIG. 1.

FIG. 3 is a partial, bottom plan view of components of a power tool handle according to the embodiment in FIG. 1.

FIG. 4 is a partial, side plan view of components of a power tool handle according to the embodiment in FIG. 1.

FIG. 5 is a partial, top plan view of components of a power tool handle according to the embodiment in FIG. 1.

FIG. 6 is a perspective view of the handle assembly component of a power tool handle according to the embodiment in FIG. 1.

FIG. 7 is a plan view of the handle assembly component of a power tool handle according to the embodiment in FIG. 1.

FIG. 8 is a perspective view of the handle-assembly-mounted isolator plate component of a power tool handle according to the embodiment in FIG. 1.

FIG. 9 is a perspective view of the handle-assembly-mounted isolator plate with adjustment rod components of a power tool handle according to the embodiment in FIG. 1.

FIG. 10 is a partial, perspective view of a power tool component according to the embodiment in FIG. 1.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

As shown in the figures for purposes of illustration, the device is embodied in a novel power tool handle that provides vibration dampening while retaining control and stability and makes use of a vibration node point for connecting the frame member to the handle assembly.

In the following description and in the figures, like elements are identified with like reference numerals. The use of “or” indicates a non-exclusive alternative without limitation unless otherwise noted. The use of “including” means “including, but not limited to,” unless otherwise noted.

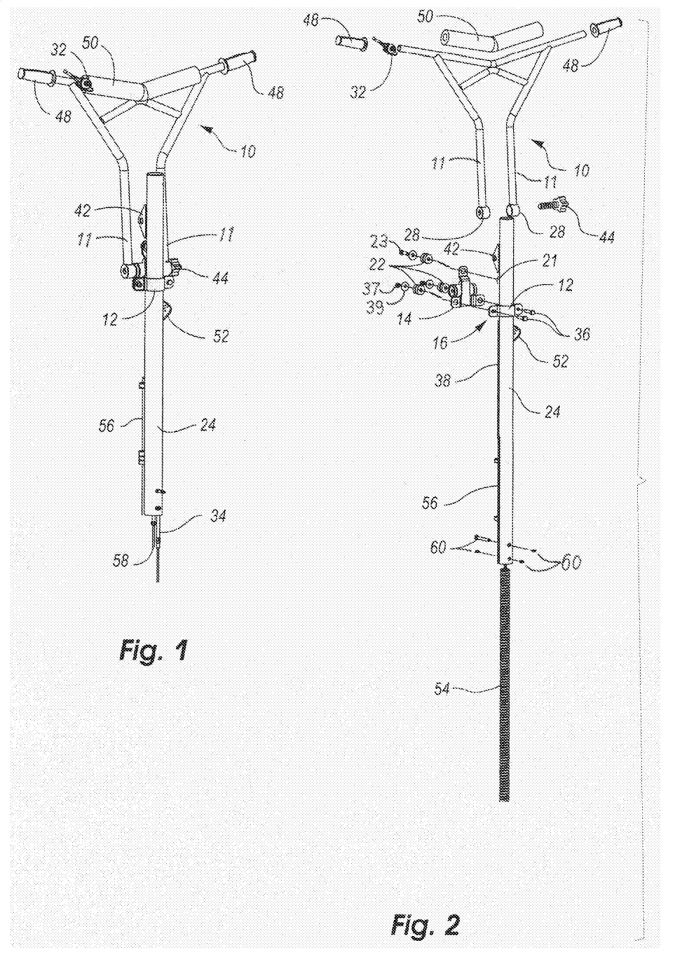

An embodiment of a vibration dampening handle assembly 10 is shown in FIGS. 1 and 2. The handle may be constructed from a variety of materials including carbon fiber, fiberglass, steel, aluminum or other rigid material. The vibration node point 16 is located during empirical analysis of the operating frame member assembly 24. Methods commonly known in the art are used to analyze vibrations along the length of the frame member assembly 24 and to locate a point of low vibration on the frame member assembly, i.e., a node point 16.

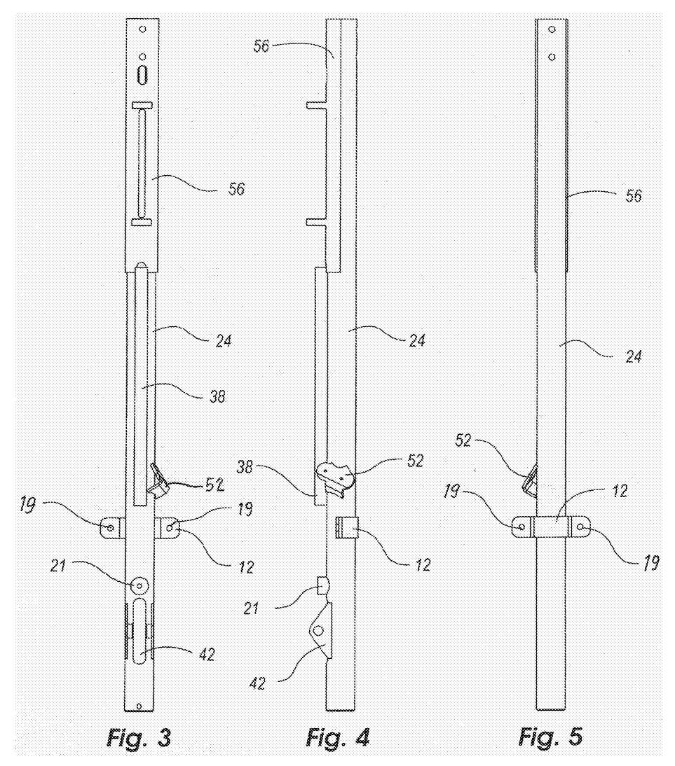

Centered around the node point 16, on the upward-facing portion of the frame member assembly 24, a frame-member-mounted isolator plate 12 is placed. The middle portion of the frame-member-mounted isolator plate 12 is shaped to fit around a portion of the cylindrical frame-member assembly 24. The frame-member-mounted isolator plate 12 defines two frame-assembly distal contact points 19, each on either side of the plate 12 (as shown in FIGS. 3 and 5).

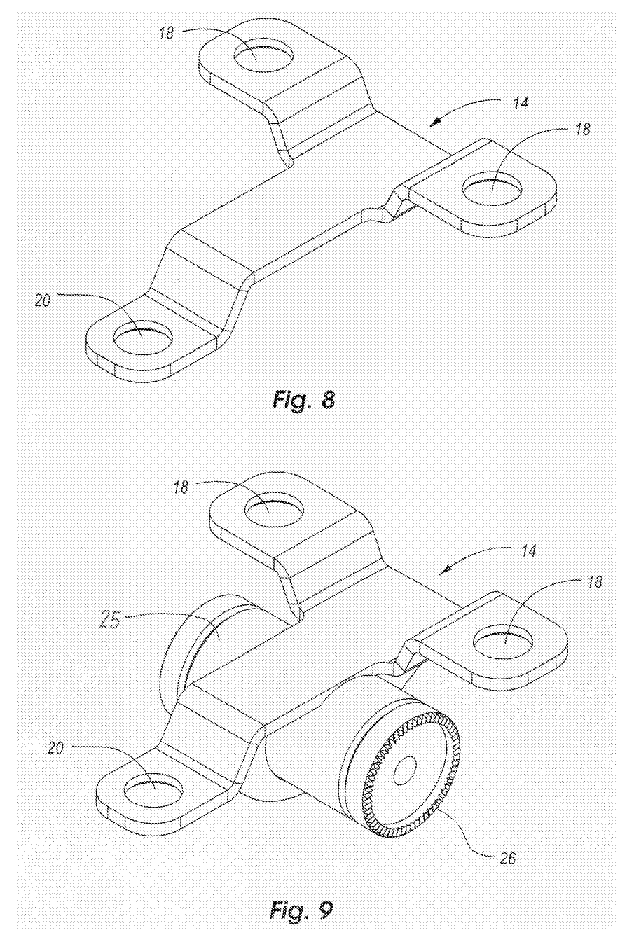

Also centered around the node point 16, on the downward-facing portion of the frame member assembly 24, a handle-assembly-mounted isolator plate 14. The handle-mounted isolator plate 14 defines two handle-assembly distal contact points 18 (as shown in FIGS. 8 and 9), which align with the frame-assembly distal contact points 19. The handle-mounted isolator plate 14 also defines a proximal contact point 20 (as shown in FIGS. 8 and 9), which aligns the frame-assembly proximal contact point 21, which is located to one side of the node point 16 along the length of the frame assembly 24.

A grommet 22 made of a resilient material is inserted into each handle-assembly distal contact point 18. Each grommet 22 is then aligned with the frame-assembly distal contact point 19. A distal point screw 36 is inserted through each frame-assembly distal point 19 and the aligned grommet 22 in the aligned handle-assembly distal point 18, and is secured in place by a nut 37. A washer 39 may be placed between each nut 37 and each grommet 22 to protect the grommet 22 from wear. Accordingly, in the preferred embodiment shown in FIGS. 1 and 2, the handle-assembly-mounted isolator plate 14 does not come into direct contact with the frame-member-mounted isolator plate.

A grommet 22 is also inserted into the proximal contact point 20 on the handle-mounted isolator plate 14. The grommet 22 inserted in the proximal contact point 20 is aligned with the frame-assembly proximal contact point 21. In some embodiments, the frame-assembly proximal contact point 21 is threaded and shaped to receive a proximal point screw 23. The proximal point screw 23 is inserted through the grommet 22, which was inserted in the proximal contact point 20, and screwed into the threaded frame-assembly proximal contact point 21. A washer 39 may be placed between the proximal point screw 23 and the grommet 22 to protect the grommet 22 from wear. Accordingly, in the preferred embodiment shown in FIGS. 1 and 2, the handle-assembly-mounted isolator plate 14 does not come into direct contact with the frame-assembly proximal contact point 21.

When installed, the distal point screws 36 and proximal point screw 23 firmly connect the frame-member-mounted isolator plate 12 and the handle-assembly-mounted isolator plate 14 to the frame assembly 24, preferably centered on the node point 16. In some embodiments, the frame-member-mounted isolator plate 12 may be welded to the node point 16 area of the frame assembly 24.

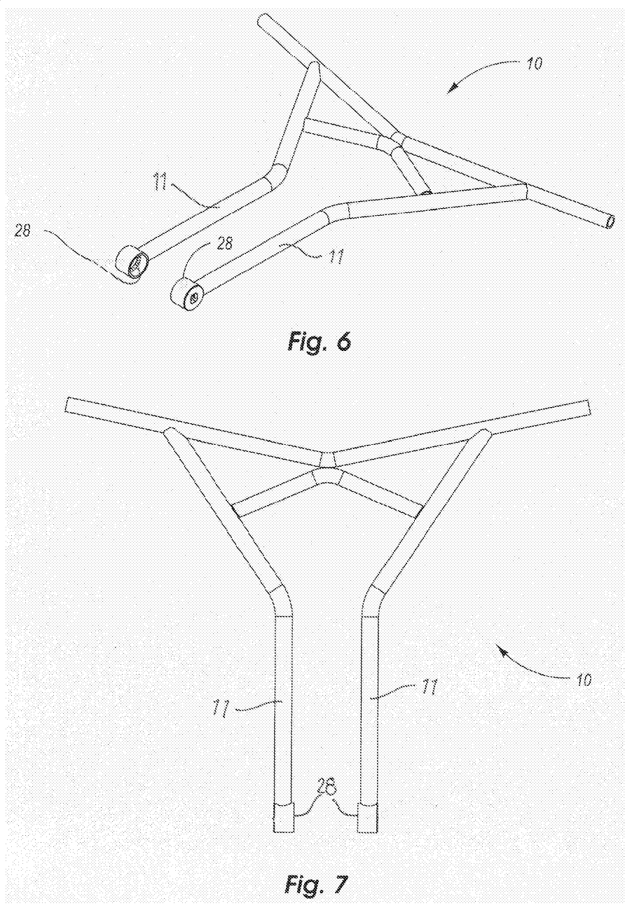

In the preferred embodiment shown in FIGS. 1 and 2, attached to the handle-assembly-mounted isolator plate 14 is an adjustment rod 25 (as shown in FIG. 9) that makes up a part of an adjustable height mechanism. The adjustment rod has two ends, and is shown in this embodiment each containing a jagged adjustment-rod mating surface 26 as shown in FIG. 9. In other embodiments, other means of interlocking the mating surfaces may be accomplished by the use of a wave-profile or interlocking cones. The handle assembly 10 may include two legs 11 having jagged handle-assembly mating surfaces 28 as shown in FIG. 6. The jagged handle-assembly mating surfaces 28 are capable of interlocking with the jagged adjustment-rod mating surfaces 26. Each of the two legs 11 has a hole passing through the jagged handle-assembly mating surface 28. The adjustment rod 25 also has a hole passing through its center and through its jagged adjustment-rod mating surfaces 26. A threaded height adjustment bolt 44 is threaded through the hole of one leg 11, passing through one jagged-handle-assembly mating surface 28 of the leg 11, then through a jagged adjustment-rod mating surface 26, through the length of the hole passing through the center of the adjustment rod 25, then through the second jagged adjustment-rod mating surface 26, and finally through the second hole of the other leg 11, thereby passing through the second jagged-handle-assembly mating surface 28. In this way, when the threaded height adjustment bolt 44 is tightened, each jagged-handle-assembly mating surface 28 of each leg 11 interlocks with the one jagged adjustment-rod mating surface 26.

The height of the handle assembly 10 above the ground may be controlled using the height adjustment mechanism. To adjust the height of the handle assembly 10 to a comfortable position, the operator loosens the threaded height adjustment bolt 44 passing through the jagged-handle-assembly mating surfaces 28 of each leg 11 of the handle assembly 10 and through the jagged adjustment-rod mating surfaces 26 of the adjustment rod 25. When the threaded height adjustment bolt 44 is loosened, the otherwise interlocking jagged handle-assembly mating surfaces 28 disengage the jagged adjustment-rod mating surfaces 26. The operator then raises or lowers the handle assembly, pivoting the same around the axis defined by the threaded height adjustment bolt 44. When the handle assembly 10 is positioned at the desired height, the operator retightens the threaded height adjustment bolt 44 thereby interlocking the jagged handle-assembly mating surfaces 28 with the jagged adjustment-rod mating surfaces 26.

As shown in FIGS. 1 and 2, in some embodiments, handle pads 50 and handle grips 48 may be added to the handle assembly 10. A throttle control device 32 may also be included to assist in the operation of the power tool. A pitch bracket 42 may be attached to the frame member assembly 24 for the addition of a pitch mechanism. Further, a control mount 52 may be attached to the frame member assembly 24 for the attachment of a kill switch mechanism to quickly shut off the power tool. A reinforcement bar 38 and/or reinforcement plate 56 (shown in FIGS. 3, 4, and 5) may be attached to the frame member assembly 24 for reinforcement.

In some embodiments, such as that shown in FIGS. 1 and 2, at least a portion of the frame member assembly 24 may be hollow so as to include a pitch adjustment spring 54, a pitch adjustment cable 34, and/or a throttle cable 58, which may be secured in place with the use of tool attachment bolts 60. These components are commonly used in the field in the operation of power tools.

FIGS. 3, 4, and 5 show different views of the frame member assembly 24 component used in the embodiment shown in FIGS. 1 and 2, along with the frame-member-mounted isolator plate 12, a reinforcement bar 38, a reinforcement plate 56, a pitch bracket 42, and a control mount 52.

FIGS. 6 and 7 show different views of the handle bar assembly 10 and particularly the two legs 11 with their jagged-handle-assembly mating surfaces 28.

FIG. 8 shows the handle-assembly-mounted isolator plate 14 with its two handle-assembly distal points 18 and its proximal contact point 20.

FIG. 9 shows a handle-assembly-mounted isolator plate 14 with an adjustment rod 25 attached. In some embodiments, the adjustment rod 25 may be welded to the handle-assembly-mounted isolator plate 14. FIG. 9 also provides a better view of one configuration for the jagged adjustment-rod mating surfaces 26 of the adjustment rod 25.

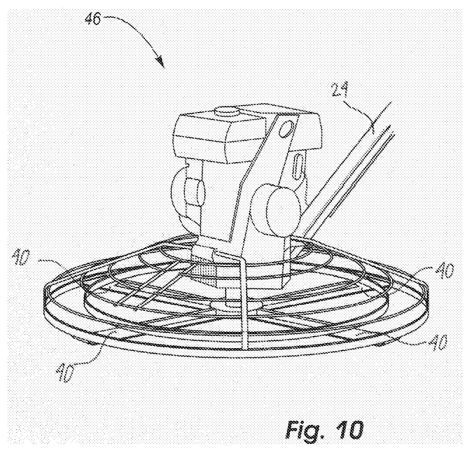

FIG. 10 shows a view of the power tool portion, in this case a power trowel 46 having a number of trowel blades 40, attached to the frame member assembly 24.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A vibration control handle for a power tool, comprising:
at least one frame member assembly attached to said power tool;
at least one handle assembly for providing user-controlled interface including directional, torsional, and axial control of said power tool;
at least one frame-member-mounted isolator plate attached to said frame member assembly at a vibration node point of said frame member assembly for dampened transmission of vibrations to said handle assembly;
at least one handle-assembly-mounted isolator plate for connection of said handle assembly to said frame-member-mounted isolator plate; and
resilient material located between said frame-member-mounted isolator plate and said handle-assembly-mounted isolator plate, wherein said resilient material dampens the vibrations transferred from said frame member assembly to said handle assembly.

2. The vibration control handle of claim 1, wherein
said frame-member-mounted isolator plate defines at least one frame-assembly distal contact point;
said frame member assembly further comprises at least one frame-assembly proximal contact point; and
said handle-assembly-mounted isolator plate defines at least one handle-assembly distal contact point and at least one proximal contact point;

3. The vibration control handle of claim 1, wherein said resilient material comprises a visco-elastic polymer.

4. The vibration control handle of claim 1, wherein said resilient material comprises rubber.

5. The vibration control handle of claim 1 further comprising an adjustable height mechanism for adjusting the height of said handle assembly.

6. The vibration control handle of claim 5, wherein said adjustable height mechanism comprises an adjustment rod having more than one interlocking adjustment-rod mating surface and at least one threaded height adjustment bolt, wherein said handle assembly further comprises more than one leg, wherein each leg comprises a interlocking handle-assembly mating surface, whereby at least one of said interlocking adjustment-rod mating surface interlocks with at least one of said interlocking handle-assembly mating surface when said threaded height adjustment bolt is tightened and whereby at least one of said interlocking handle-assembly mating surface is able to disengage from said interlocking adjustment-rod mating surface when said threaded height adjustment bolt is loosened such that an operator of said power tool may adjust the height of said handle assembly by pivoting said handle assembly around an axis defined by said threaded height adjustment bolt and then tighten said threaded height adjustment bolt so as to interlock at least one of said interlocking adjustment-rod mating surface with at least one of said interlocking handle-assembly mating surface.

7. The vibration control handle of claim 6, wherein said interlocking handle-assembly mating surface comprises a jagged interlocking handle-assembly and wherein said interlocking adjustment-rod mating surface comprise a jagged interlocking adjustment-rod mating surface.

8. A vibration control handle for a floor-standing power tool, comprising:
a frame member assembly attached to said floor-standing power tool;
at least one handle assembly for providing user-controlled interface including directional, torsional, and axial control of said floor-standing power tool;
at least one frame-member-mounted isolator plate attached to said frame member assembly at a vibration node point of said frame member assembly for dampened transmission of vibrations to said handle assembly;
at least one handle-assembly-mounted isolator plate for connection of said handle assembly to said frame-member-mounted isolator plate; and
resilient material located between said frame-member-mounted isolator plate and said handle-assembly-mounted isolator plate, wherein said resilient material dampens the vibrations transferred from said frame member assembly to said handle assembly.

9. The vibration control handle of claim 8, wherein
said frame-member-mounted isolator plate defines at least one frame-assembly distal contact point;
said frame member assembly further comprises at least one frame-assembly proximal contact point; and
said handle-assembly-mounted isolator plate defines at least one handle-assembly distal contact point and at least one proximal contact point;

10. The vibration control handle of claim 8, wherein said resilient material comprises a visco-elastic polymer.

11. The vibration control handle of claim 8, wherein said resilient material comprises rubber.

12. The vibration control handle of claim 8 further comprising an adjustable height mechanism for adjusting the height of said handle assembly.

13. The vibration control handle of claim 8, wherein said adjustable height mechanism comprises an adjustment rod having more than one interlocking adjustment-rod mating surface and at least one threaded height adjustment bolt, wherein said handle assembly further comprises more than one leg, wherein each leg comprises a interlocking handle-assembly mating surface, whereby at least one of said interlocking adjustment-rod mating surface interlocks with at least one of said interlocking handle-assembly mating surface when said threaded height adjustment bolt is tightened and whereby at least one of said interlocking handle-assembly mating surface is able to disengage from said interlocking adjustment-rod mating surface when said threaded height adjustment bolt is loosened such that an operator of said floor-standing power tool may adjust the height of said handle assembly by pivoting said handle assembly around an axis defined by said threaded height adjustment bolt and then tighten said threaded height adjustment bolt so as to interlock at least one of said interlocking adjustment-rod mating surface with at least one of said jagged handle-assembly mating surface.

14. The vibration control handle of claim 13, wherein said interlocking handle-assembly mating surface comprises a jagged interlocking handle-assembly and wherein said interlocking adjustment-rod mating surface comprises a jagged interlocking adjustment-rod mating surface.

15. A vibration control handle for a concrete power trowel, comprising:
a frame member assembly attached to said concrete power trowel;
a handle assembly for providing user-controlled interface including directional, torsional, and axial control of said concrete power trowel;
a frame-member-mounted isolator plate attached to said frame member assembly at a vibration node point of said frame member assembly for dampened transmission of vibrations to said handle assembly;
a handle-assembly-mounted isolator plate for connection of said handle assembly to said frame-member-mounted isolator plate; and
resilient material located between said frame-member-mounted isolator plate and said handle-assembly-mounted isolator plate, wherein said resilient material dampens the vibrations transferred from said frame member assembly to said handle assembly.

16. The vibration control handle of claim 15, wherein
said frame-member-mounted isolator plate defines at least one frame-assembly distal contact point;
said frame member assembly further comprises at least one frame-assembly proximal contact point; and
said handle-assembly-mounted isolator plate defines at least one handle-assembly distal contact point and at least one proximal contact point;

17. The vibration control handle of claim 15, wherein said resilient material comprises a visco-elastic polymer.

18. The vibration control handle of claim 15, wherein said resilient material comprises rubber.

19. The vibration control handle of claim 15 further comprising an adjustable height mechanism for adjusting the height of said handle assembly.

20. The vibration control handle of claim 15, wherein said adjustable height mechanism comprises an adjustment rod having more than one interlocking adjustment-rod mating surface and at least one threaded height adjustment bolt, wherein said handle assembly further comprises more than one leg, wherein each leg comprises a interlocking handle-assembly mating surface, whereby at least one of said interlocking adjustment-rod mating surface interlocks with at least one of said interlocking handle-assembly mating surface when said threaded height adjustment bolt is tightened and whereby at least one of said interlocking handle-assembly mating surface is able to disengage from said interlocking adjustment-rod mating surface when said threaded height adjustment bolt is loosened such that an operator of said concrete power trowel may adjust the height of said handle assembly by pivoting said handle assembly around an axis defined by said threaded height adjustment bolt and then tighten said threaded height adjustment bolt so as to interlock at least one of said interlocking adjustment-rod mating surface with at least one of said interlocking handle-assembly mating surface.

21. The vibration control handle of claim 20, wherein said interlocking handle-assembly mating surface comprises a jagged interlocking handle-assembly and wherein said interlocking adjustment-rod mating surface comprises a jagged interlocking adjustment-rod mating surface.
